(19) United States
(12) Patent Application Publication
(10) Pub. No.: US 2009/0011723 A1
(43) Pub. Date: Jan. 8, 2009

(54) Transmitting apparatus

(76) Inventors: Masahiko Inamori, Osaka (JP); Hirokazu Makihara, Osaka (JP); Kazuki Tateoka, Kyoto (JP); Shingo Matsuda, Kyoto (JP)

Correspondence Address: MCDERMOTT WILL & EMERY LLP, 600 13TH STREET, NW, WASHINGTON, DC, 20005-3096, US

(21) Appl. No.: 12/216,199

(22) Filed: Jul. 1, 2008

(30) Foreign Application Priority Data
Jul. 2, 2007 (JP) 2007-174284

(51) Int. Cl. H04B 1/02

(52) U.S. Cl. 455/102

(57) ABSTRACT

A transmitting apparatus of the present invention includes an orthogonal modulator for generating a modulated signal by using an input signal; a polar-modulation-mode transmission circuit which includes a first power amplifier whose input terminal receives a phase component of the modulated signal generated by the orthogonal modulator and whose power supply terminal receives an amplitude component of the modulated signal generated by the orthogonal modulator, and which polar-modulates the modulated signal; an orthogonal-modulation-mode transmission circuit which includes a second power amplifier whose input terminal receives the modulated signal generated by the orthogonal modulator and whose power supply terminal receives a constant voltage, and which transmits the modulated signal; and a switch for connecting an output of the orthogonal modulator with an input of the polar-modulation-mode transmission circuit at the time of a high output, and for connecting the output of the orthogonal modulator and an input of the orthogonal-modulation-mode transmission circuit at the time of an low output.

### BACKGROUND OF THE INVENTION

1. Field of the Invention

The present invention relates to an apparatus for performing a transmission of radio frequency signal. More particularly, the present invention relates to a transmitting apparatus which is capable of realizing a low-power consumption operation over a wide range of power outputs.

2. Description of the Background Art

Recently, a higher performance and downsizing are important factors for a mobile phone terminal in a digital format (e.g., UMTS: Universal Mobile Transmission Standard). A transmitting apparatus, which is embedded in the mobile phone terminal so as to perform a high power amplification and a high power output, needs to have a small size, a low-power consumption and less distortion. The power consumed by the transmitting apparatus embedded in the mobile phone terminal accounts for one-half or more of a total power consumption. In order to increase a talk time of the mobile phone terminal, it is inevitable for the transmitting apparatus to operate with low-power consumption.

Generally, the power output of the transmitting apparatus ranges widely from +27 dBm to −50 dBm, and the power consumption thereof reaches a maximum at around +27 dBm, which is a maximum power output. Therefore, the power consumption at around the maximum power output needs to be reduced. On the other hand, a probability density function (PDF), which indicates use frequency in accordance with the power outputs of the transmitting apparatus, reaches a maximum at around +12 dBm, which is a relatively low power output, and is maintained at high levels in a range from +7 dBm to +17 dBm. The power consumption in the range from +7 dBm to +17 dBm is not high compared to the power consumption at the maximum power output. However, it is important to lower the power consumption in the range since the use frequency in the range is high.

Accordingly, in Japanese Laid-Open Patent Application No. 2005-20696 and U.S. Serial No. 2007/0281652 (Japanese Laid-Open Patent Application No. 2007-324846), proposed are transmitting apparatuses which are each capable of lowering the power consumption over a wide range of power outputs of the transmitting apparatus. In each of the transmitting apparatuses based on the conventional techniques, an operation mode is switched between a polar modulation mode (polar mode) at the time of a high output, and an orthogonal modulation mode (linear mode) at the time of a low output.

Generally, in the polar modulation mode, since the power amplifier provided inside the transmitting apparatus can be used in a saturated state, the power amplifier is capable of outputting a desired level of power highly efficiently, and thus it is possible to reduce the power consumption of the transmitting apparatus compared to a case of the operation in the orthogonal modulation mode. Further, in the case of the operation in the polar modulation mode, it is possible to downsize a device size of the power amplifier. Therefore, the efficiency of the power amplifier may be enhanced by switching the operation mode to the orthogonal modulation mode only at the time of the low output.

FIG. 15 is a diagram showing a circuit configuration of a conventional transmitting apparatus 100 having a function of switching the operation mode between the polar modulation mode and the orthogonal modulation mode. As shown in FIG. 15, the conventional transmitting apparatus 100 includes a mode selector 102 provided in a digital element 101, a first digital-analog converter (DAC) 103, a power amplifier 104 having an input terminal and a power supply terminal, a band-pass filter (BPF) 105, a second DAC 106, and a modulating amplifier 107.

In the case of the configuration shown in FIG. 15, when an output of the conventional transmitting apparatus 100 is high, a signal inputted to the mode selector 102 is divided into a phase component and an amplitude component. The phase component is converted, by the first DAC 103, into a phase-modulated signal having a substantially constant amplitude, whereas the amplitude component is converted, by the second DAC 106 and the modulating amplifier 107, into the amplitude-modulated signal. The phase-modulated signal is supplied to the input terminal of the power amplifier 104, whereas the amplitude-modulated signal is supplied to the power supply terminal of the power amplifier 104. In the power amplifier 104, both of the phase-modulated signal and the amplitude-modulated signal are combined together. In this manner, at the time of the high output, the conventional transmitting apparatus 100 operates in the polar modulation mode.

On the other hand, when the output of the conventional transmitting apparatus 100 is low, the signal inputted to the mode selector 102 is converted into the orthogonally-modulated signal by the first DAC 103 (at an input path side). A voltage having a substantially constant amplitude level is outputted through the second DAC 106 and the modulating-amplifier 107 (at a power supply path side). The orthogonally-modulated signal is supplied to the input terminal of the power amplifier 104, and the voltage having the constant amplitude level is supplied to the power supply terminal of the power amplifier 104, and both of the orthogonally-modulated signal and the voltage is combined together in the power amplifier 104. In this manner, the conventional transmitting apparatus 100 operates in the orthogonal modulation mode at the time of the low output.

Further, with regard to the conventional transmitting apparatuses, another transmitting apparatus having a function of switching the operation mode between the polar modulation mode and the orthogonal modulation mode will be described. FIG. 16 is a diagram showing a circuit configuration of a conventional transmitting apparatus 200 having the function of switching the operation mode between the polar modulation mode and the orthogonal modulation mode. As shown in FIG. 16, in the conventional transmitting apparatus 200, a signal inputted to the converter 201 is divided into a phase signal and an amplitude signal.

The phase signal is sent to the phase comparator 202, and inputted to an input terminal of the power amplifier 204 via a loop filter 203. An output of the power amplifier 204 is detected by a coupler, and phase information is returned to the phase comparator 202 via a mixer 209 and a limiting amplifier 211. The returned phase information and the phase signal from the modulator 201 is compared to each other, and a signal having a phase thereof adjusted based on a result of the comparison is inputted to the power amplifier 204.

The switch 207 switches a control input side of the power amplifier 204, and the switch 208 switches an output of the amplitude signal of the modulator 201. The control circuit 220 and the switches 207 and 208 are configured as a switch control unit for switch-controlling an amplitude control loop of the transmitting apparatus 200.

When the output of the power amplifier 204 is high, both of the switches 207 and 208 respectively make connections to terminals b. The amplitude signal is transmitted to an amplitude comparator 205, and then inputted to a control input terminal of the power amplifier 204 via a loop filter 206. The output of the power amplifier 204 is detected by a coupler, and amplitude information is returned to the amplitude comparator 205 via the mixer 209 and an amplitude detection circuit 210. The returned amplitude information and the amplitude signal from the modulator 201 is compared to each other, and a signal having an amplitude thereof corrected based on a result of the comparison is inputted to the control input side of the power amplifier 204. In this manner, at the time of the high output, the conventional transmitting apparatus 200 operates in the polar modulation mode.

On the other hand, when the output of the power amplifier 204 is low, both of the switches 207 and 208 make connections to terminals a. A loop-circuit including the amplitude comparator 205 and the loop filter 206 as above described becomes open, and the amplitude signal from the modulator 201 is directly inputted to the power amplifier 204. In this manner, at the time of the low output, the conventional transmitting apparatus 200 operates in the orthogonal modulation mode.

As above-described, each of the conventional transmitting apparatuses 100 and 200 operates in a switched manner between the polar modulation mode at the time of the high output and the orthogonal modulation mode at the time of the low output. Accordingly, a high efficiency of the power amplifier can be achieved, and the power consumption of the transmitting apparatus can be reduced.

Hereinafter, problems of the conventional transmitting apparatuses will be exemplified by using the above-described conventional transmitting apparatus 100. In the above-described conventional transmitting apparatus 100, a saturation output of the power amplifier 104 can be reduced approximately by +3 dB by operating the transmitting apparatus 100 in the polar modulation mode at the time of the high output, compared to a case where the transmitting apparatus 100 is operated in the orthogonal modulation mode. That is, in the case of the polar modulation mode, the device size of the power amplifier 104 can be reduced by one-half of the device size of the same in the case of the orthogonal modulation mode.

Generally, the power amplifier reaches its maximum efficiency at around the saturation output, and thus if the device size thereof is selected so as to be adapted to the high output, the low-power consumption operation is achievable at the time of the high output. However, if the device size of the power amplifier 104 of the conventional transmitting apparatus 100 is set based on the high output, the device size is not suitable for the power amplifier to exert its maximum efficiency at the time of the low output.

For example, in the case of a mobile phone system in the UMTS format, the maximum output of the transmitting apparatus is +27 dBm, whereas the low output, which is highly frequently used, ranges from +7 to +17 dBm. A ratio between the two power outputs ranges 1/100 to 1/10. The maximum output and the low output are extremely different from each other. Therefore, in order to derive the maximum efficiency of the power amplifier in the transmitting apparatus in accordance with the outputs, the device size needs to be considered in accordance with the outputs of the transmitting apparatus. That is, in the case of the low output, the power output thereof is 1/10 of that of the high output. Therefore, in order to derive the maximum efficiency, the device size in the case of the low output needs to be set to 1/10 of the device size in the case of the high output. By operating the conventional transmitting apparatus 100 in the polar modulation mode, the device size thereof can be reduced to approximately one-half compared to a case where the transmitting apparatus 100 is operated in the orthogonal modulation mode only. However, the maximum efficiency in accordance with the power output ratio is yet to be derived. Therefore, in the conventional transmitting apparatus 100, the low-power consumption operation is not achieved sufficiently.

Further, in the case of the high output, the power consumption of the power amplifier 104 accounts for as high as approximately 70% of a total power consumption of the conventional transmitting apparatus 100. Accordingly, it is extremely important to operate the power amplifier 104 highly efficiently.

On the other hand, in the case of the low output, the power consumption of the power amplifier 104 is significantly decreased compared to the case of the high output, and accounts for approximately 30% or lower of the total power consumption of the conventional transmitting apparatus 100. Therefore, not only the power amplifier 104, but the first DAC 103, the second DAC 106 and the modulating amplifier 107 also have a great impact on the power consumption of the conventional transmitting apparatus 100. That is, it is extremely important to set the first DAC 103, the second DAC 106 and the modulating amplifier 107 so as to derive their maximum efficiencies in accordance with the outputs.

However, the first DAC 103, the second DAC 106 and the modulating amplifier 107 are each of a device size and in a circuit configuration so as to be adapted to the high power output in the polar modulation mode. Therefore, even if the operation mode is switched to the orthogonal modulation mode at the time of the lower output, the power consumption cannot be reduced sufficiently.

FIG. 17 is a diagram showing a relation between the power output and the power consumption of the transmitting apparatus. With regard to a feature A2 (represented by a bold dashed lines) of the conventional transmitting apparatus 100, which is operated by switching between the polar modulation mode and the orthogonal modulation mode, the power amplifier is used in a saturation state at around the maximum output (+27 dBm), and the desired power can be outputted highly efficiently. Accordingly, the feature indicates the low-power consumption compared to a feature A1 (represented by a thin dashed lines) of the transmitting apparatus, which is operated in the orthogonal modulation mode only.

However, at the time of the low output, where the power output is approximately +17 dBm or lower, the power consumption does not show any difference between the feature A1 and the feature A2. For example, when the mobile phone is frequently used at a location which is relatively close to a base station and which has a good reception state, the transmitting apparatus operates in the low output range of +17 dBm or lower. When the conventional transmitting apparatus 100 is used in this case, the power consumption thereof is not particularly different from the power consumption of the transmitting apparatus which is operated in the conventional orthogonal modulation only. That is, a problem is posed in that the conventional transmitting apparatus 100 does not bring a significant improvement in the talk time of the mobile phone.

As above described, according to the configuration of the conventional transmitting apparatus 100, the first DAC 103, the power amplifier 104, the second DAC 106, and the modulating amplifier 107 operates regardless of the outputs of the transmitting apparatus. Accordingly, performances of the power amplifier 104 and the remaining devices, which is used both at the time of the low output and at the time of the high output, are optimized in accordance with the performances at the time of the maximum output. Therefore, it is difficult to derive the maximum efficiency of each of the devices in accordance with the outputs of the transmitting apparatus. Further, at the time of the low output, it is impossible to cause each of the devices to operate highly efficiently. Consequently, a problem is posed in that the total power consumption of the transmitting apparatus cannot be reduced sufficiently. In the case of the conventional transmitting apparatus 200, since the power amplifier 204 is used at the time of the low output as well as the high output, the same problem is posed.

### SUMMARY OF THE INVENTION

Therefore, an object of the present invention is to provide an transmitting apparatus which derives a maximum efficiency of a transmission circuit therein in accordance with an output of the transmitting apparatus, and which realizes a low-power consumption operation over a wide range of outputs.

The present invention is directed to a transmitting apparatus which is capable of switching the transmission circuits in accordance with a magnitude of the power output of the transmitting apparatus. The transmitting apparatus according to the present invention generates a modulated signal and amplifies power. The above-described object of the present invention is attained by the transmitting apparatus comprising: an orthogonal modulator for generating the modulated signal by using an input signal; a polar-modulation-mode transmission circuit which includes a first power amplifier whose input terminal receives a phase component of the modulated signal generated by the orthogonal modulator and whose power supply terminal receives an amplitude component of the modulated signal generated by the orthogonal modulator, and which polar-modulates the modulated signal, an orthogonal-modulation-mode transmission circuit which includes a second power amplifier whose input terminal receives the modulated signal generated by the orthogonal modulator and whose power supply terminal receives a constant voltage, and which transmits the modulated signal; and a switch for connecting the orthogonal modulator with the polar-modulation-mode transmission circuit at the time of a high output when a power output of the transmitting apparatus is at a high level, and for connecting the orthogonal modulator with the orthogonal-modulation-mode transmission circuit at the time of a low output when the power output of the transmitting apparatus is at a low level.

Preferably, the polar-modulation-mode transmission circuit in the transmitting apparatus of the present invention further includes: an amplitude/phase converter for dividing the modulated signal generated by the orthogonal modulator into the amplitude component and the phase component; a voltage control oscillator for generating a phase-modulated signal having a constant amplitude by using the phase component which is divided into by the amplitude/phase converter; and a first power source IC for generating an amplitude-modulated signal by using the amplitude component which is divided into by the amplitude/phase converter. An output of the voltage control oscillator is inputted to the input terminal of the first power amplifier, and an output of the first power source IC is inputted to the power supply terminal of the first power amplifier.

Preferably, orthogonal-modulation-mode transmission circuit in the transmitting apparatus of the present invention further includes a second power source IC for supplying the constant voltage to the power supply terminal of the second power amplifier. Further preferably, the orthogonal-modulation-mode transmission circuit in the transmitting apparatus of the present invention further includes a band-pass filter for band-limiting the modulated signal generated by the orthogonal modulator. An output of the band-pass filter is inputted to the input terminal of the second power amplifier.

With the above-described configuration, at the time of the high output when the power output of the transmitting apparatus is at the high level, the signal generated by the orthogonal modulator is inputted to the amplitude/phase converter in the polar-modulation-mode transmission circuit via the switch, and then divided into the amplitude component and the phase component. The phase component is converted, by the voltage control oscillator, into the phase-modulated signal having a constant amplitude, whereas the amplitude component is converted into the amplitude-modulated signal by the first power source IC. The phase-modulated signal is inputted to the input terminal of the first power amplifier, whereas the amplitude-modulated signal is supplied to the power supply terminal of the first power amplifier. In the first power amplifier, both of the phase-modulated signal and the amplitude-modulated signal are combined together, and then a resultant signal combined by the first power amplifier is outputted. In this manner, at the time of the high output, the transmitting apparatus according to the present invention operates in the polar modulation mode.

At the time of the low output, when the power output of the transmitting apparatus is at the low level, the signal generated by the orthogonal modulator is inputted to a BPF in the orthogonal-modulation-mode transmission circuit via the switch. The signal which is band-limited by the BPF is inputted to the input terminal of the second power amplifier, whereas a constant voltage generated by the second power source IC is supplied to the power supply terminal of the second power amplifier. In the second power amplifier, the signal and the constant voltage is combined together, and then a resultant signal combined by the second power amplifier is outputted. In this manner, at the time of the low output, the transmitting apparatus according to the present invention operates in the orthogonal modulation mode.

As above described, at the time of the high output, the polar-modulation-mode transmission circuit performs the polar modulation, and thus a device size of the first power amplifier can be set one-half of that in the case of the orthogonal modulation. Therefore, it is possible to operate the first power amplifier at or near its saturation output, and consequently possible to derive a maximum efficiency of the first power amplifier. Accordingly, it is possible to operate the first power amplifier with a low-power consumption.

On the other hand, at the time of the low output, orthogonal-modulation-mode transmission circuit performs the orthogonal modulation, and thus it is possible to set a device size of the second power amplifier smaller than a power amplifier in the conventional transmission circuits which needs to be adapted to the high output. Therefore, it is possible to derive a maximum efficiency of the second power amplifier, and also possible to operate the second power amplifier with the low-power consumption. Further, it is possible to make the device size of the second power amplifier smaller in accordance with a ratio of the low output to the high output.

The device size of the second power amplifier is set small, whereby a drive performance of the second power source IC can be set lower. Accordingly, reduction in the device size and a circuit scale of the second power source IC can be achieved, and the power consumption can be minimized.

Due to switching performed by the switch, the polar-modulation-mode transmission circuit and the orthogonal-modulation-mode transmission circuit do not consume unnecessary power when not being connected to the orthogonal modulator.

As above described, according to the present invention, the transmission circuits are switched in accordance with the power output of the transmitting apparatus, whereby the maximum efficiencies of the transmission circuits may be derived in accordance with the power output. Particularly, the transmitting apparatus of the present invention includes devices which are dedicated to the high output and to the low output, respectively, and thus it is possible to operate the respective devices highly efficiently both at the time of the high output and at the time of the low output. Therefore, according to the present invention, it is possible to minimize the power consumption of the transmitting apparatus over the wide range of power outputs, and a low-power consumption operation can be realized.

The transmitting apparatus of the present invention is applicable to an apparatus (e.g., a mobile phone terminal) including a bipolar transistor which transmits a radio frequency signal, and is particularly applicable to a case where a low-power consumption operation is to be realized over a wide range of power outputs.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an exemplary circuit configuration of a transmitting apparatus 10 according to a first embodiment of the present invention;

FIG. 2 is a diagram showing another exemplary circuit configuration of the transmitting apparatus 10 (a detailed description of a polar-modulation-mode transmission circuit and an orthogonal-modulation-mode transmission circuit) according to the first embodiment of the present invention;

FIG. 3 is a diagram showing a ratio of a power consumption of the first power amplifier 31 in the polar-modulation-mode transmission circuit 30 to a power consumption of the transmitting apparatus 10 according to the first embodiment of the present invention;

FIG. 4 is a diagram showing an exemplary circuit configuration in which power control terminals are provided to the transmitting apparatus 10 according to the first embodiment of the present invention;

FIG. 5 is a diagram showing a modulation mode switching timing in the transmitting apparatus 10 according to the first embodiment of the present invention;

FIG. 6 is a diagram showing an exemplary first switch 50 and a second switch 60 of the transmitting apparatus 10 according to the first embodiment of the present invention;

FIG. 7 is a diagram showing a switching timing between the first switch 50 and the second switch 60 of the transmitting apparatus 10 according to the first embodiment of the present invention;

FIG. 8 is a diagram showing a relation between a power output and a power consumption of the transmitting apparatus 10 according to the first embodiment of the present invention;

FIG. 9 is a diagram showing a circuit configuration of a transmitting apparatus 11 according to a second embodiment of the present invention;

FIG. 10 is a diagram showing a modulation mode switching timing in the transmitting apparatus 11 according to the second embodiment of the present invention;

FIG. 11 is a diagram showing a circuit configuration of a transmitting apparatus 12 according to a third embodiment of the present invention;

FIG. 12 is a diagram showing a modulation mode switching timing in the transmitting apparatus 12 according to the third embodiment of the present invention;

FIG. 13 is a diagram showing a circuit configuration of a transmitting apparatus 13 according to a fourth embodiment of the present invention;

FIG. 14 is a diagram showing an exemplary second switch;

FIG. 15 is a diagram showing a circuit configuration of a conventional transmitting apparatus 100;

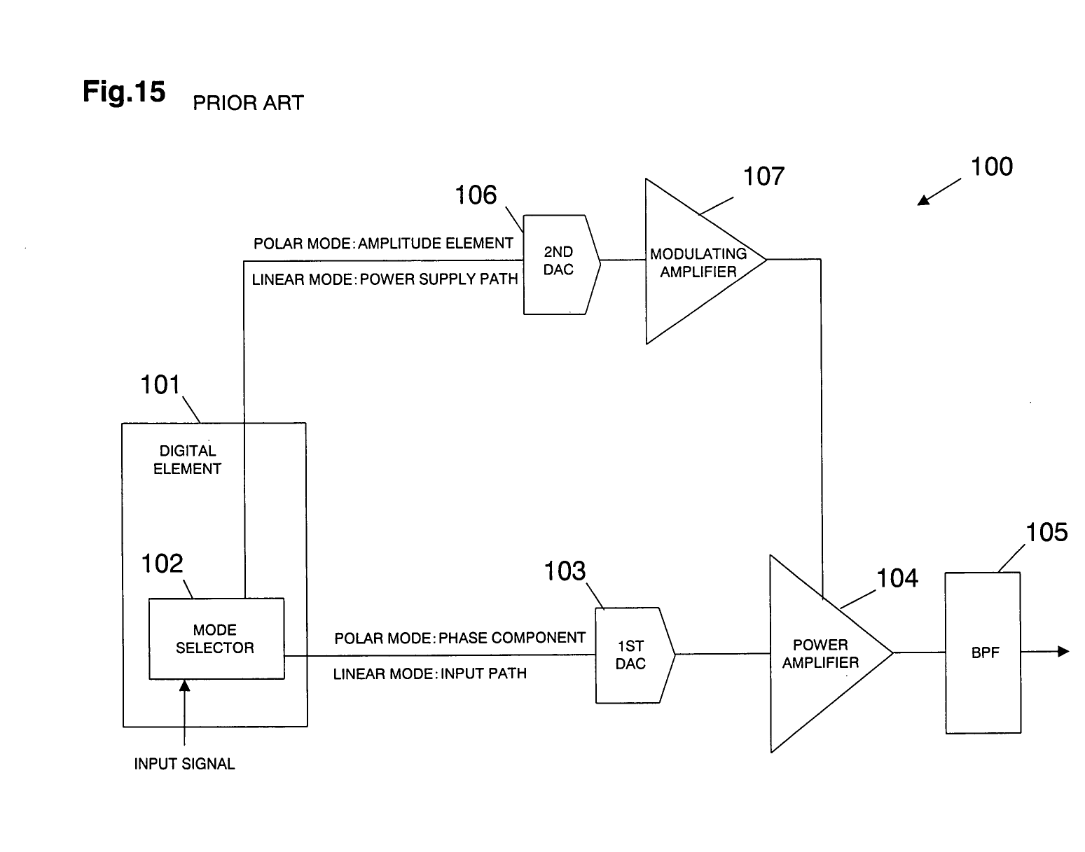

FIG. 16 is a diagram showing a circuit configuration of a conventional transmitting apparatus 200; and

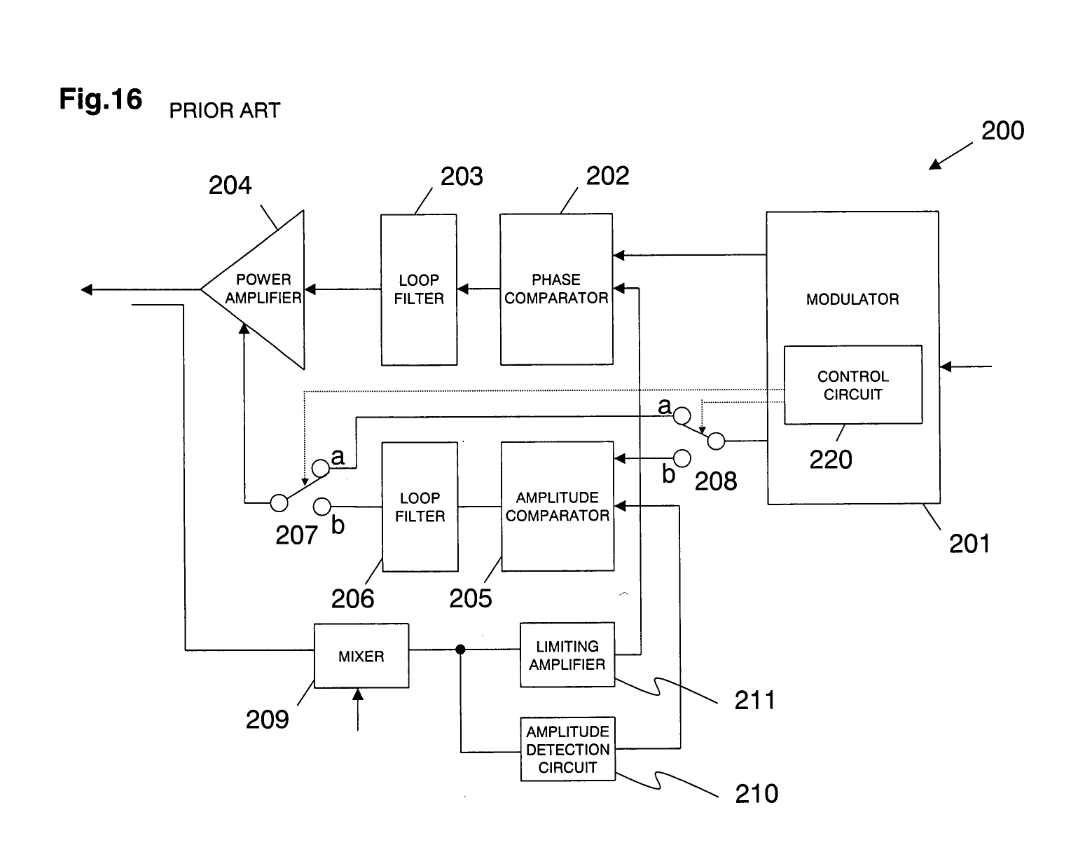

FIG. 17 is a diagram showing a relation between a power output and a power consumption of the conventional transmitting apparatus.

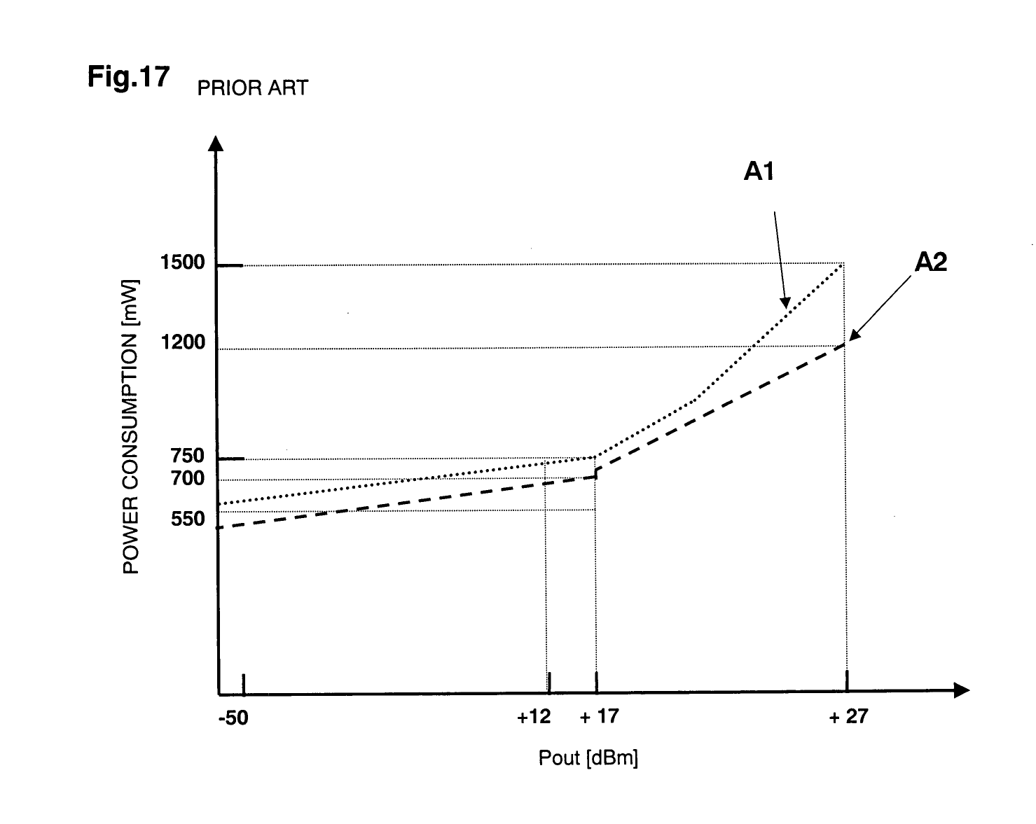

### DESCRIPTION OF THE PREFERRED EMBODIMENTS

Hereinafter, respective embodiments of the present invention will be described with reference to diagrams.

### First Embodiment

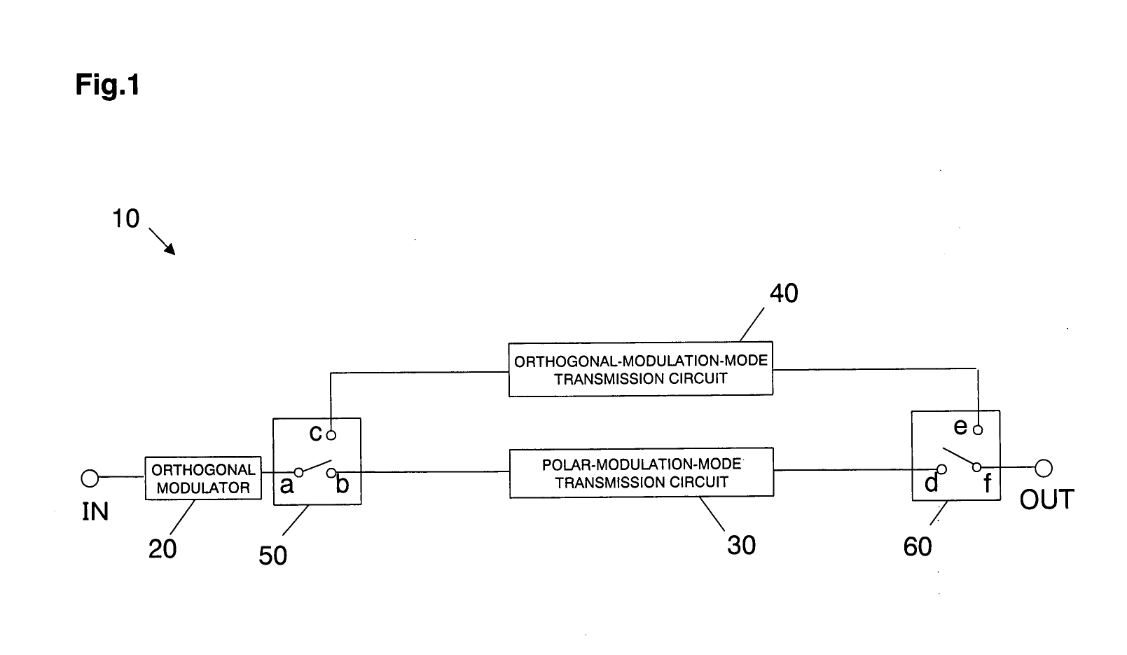

FIG. 1 is a diagram showing a circuit configuration of a transmitting apparatus 10 according to a first embodiment of the present invention. As shown in FIG. 1, the transmitting apparatus 10 includes an orthogonal modulator 20, a polar-modulation-mode transmission circuit 30, an orthogonal-modulation-mode transmission circuit 40, a first switch 50 and a second switch 60. An input terminal IN of the transmitting apparatus 10 is connected to the orthogonal modulator 20. In the first switch 50, an input terminal a is connected to an output of the orthogonal modulator 20, and an output terminal b is connected to an input of the polar-modulation-mode transmission circuit 30. Also, the output terminal c is connected to an input of the orthogonal-modulation-mode transmission circuit 40. In the second switch 60, an input terminal d is connected to an output of the polar-modulation-mode transmission circuit 30, and an input terminal e is connected to an output of the orthogonal-modulation-mode transmission circuit 40. Also, an output terminal f is connected to an output terminal OUT of the transmitting apparatus 10.

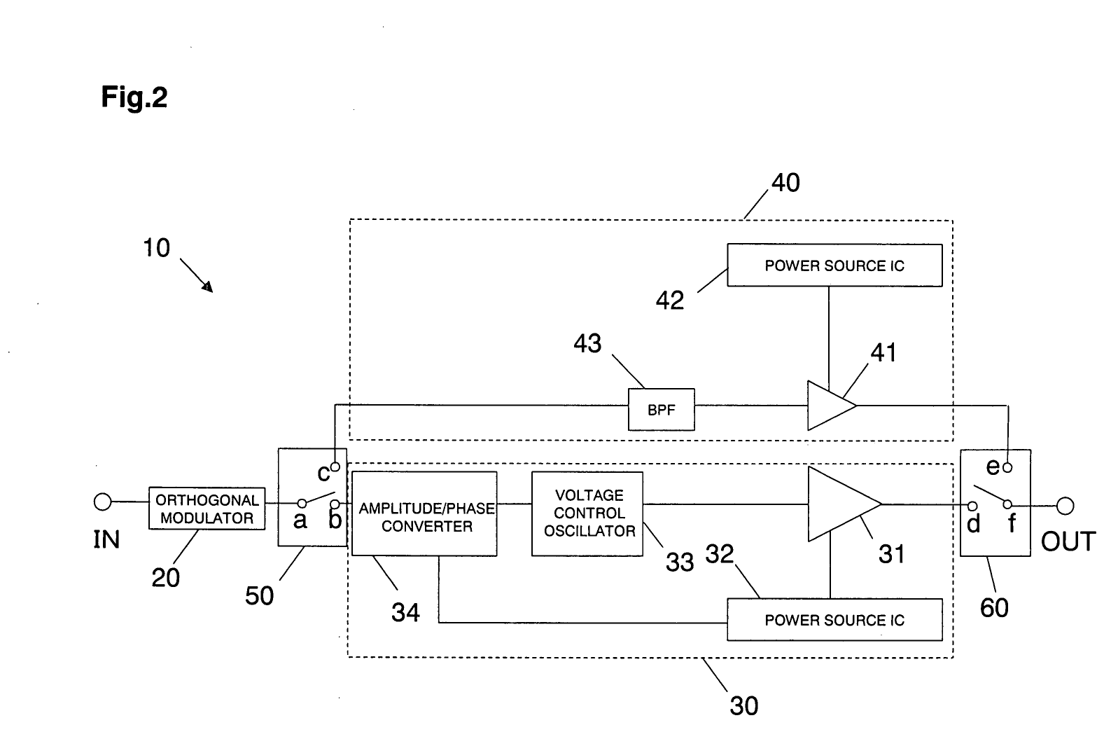

FIG. 2 is a diagram showing, in detail, the polar-modulation-mode transmission circuit 30 and the orthogonal-modulation-mode transmission circuit 40 of the transmitting apparatus 10 shown in FIG. 1. In the polar-modulation-mode transmission circuit 30, provided are an amplitude/phase converter 34 which is connected to the output terminal b of the first switch 50, a voltage control oscillator 33 whose input terminal is connected to an output terminal of a phase component of the amplitude/phase converter 34, a first power source IC 32 whose input terminal is connected to an output terminal of the amplitude component of the amplitude/phase converter 34, a first power amplifier 31 whose input terminal is connected to an output of the voltage control oscillator 33 and whose power supply terminal is connected to an output of the first power source IC 32. An output of the first power amplifier 31 is connected to the input terminal d of the second switch 60.

In the orthogonal-modulation-mode transmission circuit 40, provided are a BPF 43 which is connected to an output terminal c of the first switch 50, a second power source IC 42, and a second power amplifier 41 whose input terminal is connected to an output of the BPF 43 and whose power supply terminal is connected to an output of the second power source IC 42. An output of the second power amplifier 41 is connected to an input terminal e of the second switch 60.

As a feature of the transmitting apparatus 10, the polar-modulation-mode transmission circuit 30 and the orthogonal-modulation-mode transmission circuit 40 respectively include the first power amplifier 31 and the second power amplifier 41, which are power amplifiers dedicated thereto, respectively, and also include the first power source IC 32 and the second power source IC 42 which are also dedicated thereto, respectively.

The orthogonal modulator 20 generates a modulated signal from an input signal of the transmitting apparatus 10. The first switch 50 and the second switch 60 are controlled by a control section (not shown) which determines whether a power output of the transmitting apparatus 10 is high or low in accordance with the signal inputted to the transmitting apparatus 10. Therefore, the modulated signal generated by the orthogonal modulator 20 is modulated by the polar-modulation-mode transmission circuit 30 at the time of the high output, when a level of the power output of the transmitting apparatus 10 is high, whereas the modulated signal is amplified by the orthogonal-modulation-mode transmission circuit 40 at the time of the low output, when the level of the power output of the transmitting apparatus 10 is low. The signal is then outputted to the output terminal OUT. Hereinafter, timings at which the first switch 50 and the second switch 60 switch between the polar-modulation-mode transmission circuit 30 and the orthogonal-modulation-mode transmission circuit 40 will be described.

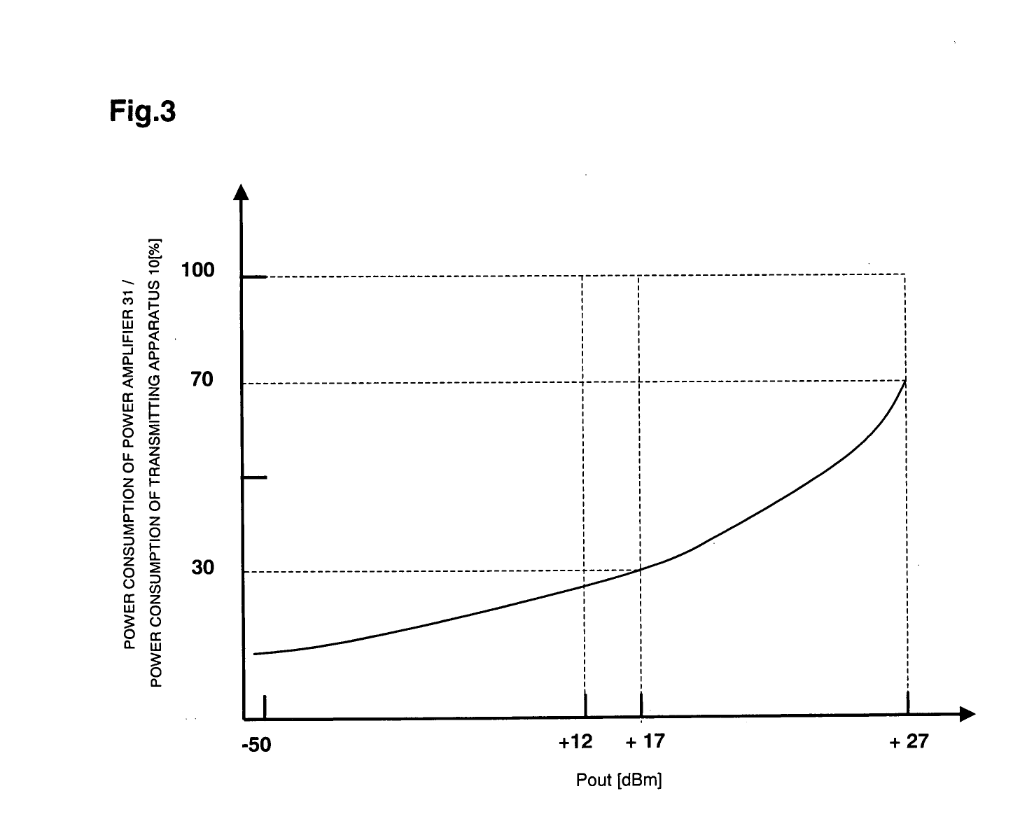

FIG. 3 shows a diagram showing a ratio of a power consumption of the first power amplifier 31 included in the polar-modulation-mode transmission circuit 30 to a power consumption of the transmitting apparatus 10 in the case where the transmitting apparatus 10 is operated in the polar modulation mode for all ranges of power outputs. When the power output is +27 dBm, the ratio is as high as 70%. When the power output is reduced to +17 dBm, the ratio is decreased to 30%. When the power output is reduced further, the ratio is also decreased further. This indicates that when the transmitting apparatus 10 is operated in the polar modulation mode at the time of the low output, the first power amplifier 31 does not contribute to the low-power consumption operation of the transmitting apparatus 10. That is, at the time of the low output, power consumptions of the first power source IC 32, the voltage control oscillator 33, and the amplitude/phase converter 34 included in the polar-modulation-mode transmission circuit 30 cannot be ignored. Therefore, at the time of the low output, the total power consumption of the polar-modulation-mode transmission circuit 30 increases, and thus switching needs to be performed from the polar-modulation-mode transmission circuit 30 to the orthogonal-modulation-mode transmission circuit 40.

That is, the switching between the polar-modulation-mode transmission circuit 30 and the orthogonal-modulation-mode transmission circuit 40 is performed at a timing when the ratio of the power consumption of the first power amplifier 31 included in the polar-modulation-mode transmission circuit 30 to the power consumption of the transmitting apparatus 10 becomes approximately 30%. It is preferable that the switching timing is not set when the power output is around +12 dBm, which is a peak of a use frequency, but is set when the power output is +17 dBm, for example, where the use frequency is slightly decreased from the peak.

As above described, in the case of the high power output of +17 dBm or more, the first switch 50 is controlled to cause the input terminal a to be connected to the output terminal b at the side of the polar-modulation-mode transmission circuit 30, and the second switch 60 is also controlled to cause the output terminal f to be connected to the input terminal d at the side of the polar-modulation-mode transmission circuit 30. In the case of low power output lower than +17 dBm, the first switch 50 is controlled to cause the input terminal a to be connected to the output terminal c at the side of the orthogonal-modulation-mode transmission circuit 40, and the second switch 60 is also controlled to cause the output terminal f to be connected to the input terminal e at the side of the orthogonal-modulation-mode transmission circuit 40.

In the case of the configuration shown in FIG. 2, a signal generated by the orthogonal modulator 20 is inputted to the amplitude/phase converter 34 of the polar-modulation-mode transmission circuit 30 via the first switch 50, and then divided into an amplitude component and a phase component at the time of the high output. The phase component is converted, by the voltage control oscillator 33, into a phase-modulated signal having substantially a constant amplitude, whereas the amplitude component is converted, by the first power source IC 32, into an amplitude-modulated signal. The phase-modulated signal is inputted to the input terminal of the first power amplifier 31, whereas the amplitude-modulated signal is provided to the power supply terminal of the first power amplifier 31, and both of the phase-modulated signal and the amplitude-modulated signal are combined together by the first power amplifier 31. The signal combined by the first power amplifier 31 is outputted via the second switch 60. In this manner, at the time of the high output, the transmitting apparatus 10 according to the present embodiment operates in the polar modulation mode.

At the time of the low output, the signal generated by the orthogonal modulator 20 is inputted to the BPF 43 of the orthogonal-modulation-mode transmission circuit 40 via the first switch 50, and is band-limited. The signal band-limited in the BPF 43 is inputted to the input terminal of the second power amplifier 41, and a constant voltage which is generated by the second power source IC 42 is supplied to the power supply terminal of the second power amplifier 41, and the band-limited signal and the constant voltage is combined together by the second power amplifier 41. The signal combined by the second power amplifier 41 is outputted via the second switch 60. In this manner, at the time of the low output, the transmitting apparatus 10 according to the present embodiment operates in the orthogonal modulation mode.

The first power amplifier 31 has the same circuit configuration as the second power amplifier 41, however, device sizes thereof are set differently in accordance with saturation outputs of the power amplifiers. In the present embodiment, the device size of the first power amplifier 31 is set so as to be adapted to the high output up to +27 dBm (501 mW). The device size of the second power amplifier 41 is set so as to be approximately ⅕ as small as the device size of the first power amplifier 31. This is because the second power amplifier 41 operates in the orthogonal modulation mode which requires linearity of the power amplifier, and in order for the second power amplifier 41 to be adapted to the output up to +17 dBm (50.1 mW), the saturation output needs to be set higher than a desired output, by approximately +3 dBm, to +20 dBm (100 mW).

The drive performances of the first power source IC 32 and the second power source IC 42 are set so as to be adapted to the device sizes of the first power amplifier 31 and the second power amplifier 41, respectively. The first power source IC 32 needs to have a drive performance of 3.5V output voltage and 250 mA current so as to allow the first power amplifier 31 to be adapted to the high output. On the other hand, the second power source IC 42 may have a drive performance of 1.8V output voltage and 100 mA current, since the second power amplifier 41 corresponds to the low output. Accordingly, the device size of the second power source IC 42 can be set to ⅕ as small as the device size of the first power source IC 32. Further, with respect to the first power source IC 32, a dedicated circuit such as an operational amplifier is required additionally, so as to convert the amplitude component of the inputted signal, which is divided by the amplitude/phase converter 34, into the amplitude-modulated signal. On the other hand, with respect to the second power source IC 42, the dedicated circuit such as the operational amplifier is not required since only a constant voltage signal is generated thereby.

As above described, in the orthogonal-modulation-mode transmission circuit 40, it is possible to have the second power amplifier 41 and the second power source IC 42 of optimum device sizes, respectively, as the transmission circuit for the low output. In the conventional transmitting apparatus, the respective device sizes are set so as to be adapted to the high output, and thus the respective device cannot be operated highly efficiently at the time of the low output. However, in the transmitting apparatus 10 according to the present embodiment, it is possible to derive the optimum efficiencies of the respective devices even at the time of the low output, and also possible to minimize a size of the circuit and the power consumption.

Further, the polar-modulation-mode transmission circuit 30 may be operated only at the time of the high output, whereas the orthogonal-modulation-mode transmission circuit 40 may be operated only at the time of the low output. Therefore, preferably, both of the transmission circuits are set so as not to consume unnecessary power during time periods other than the respective operation times.

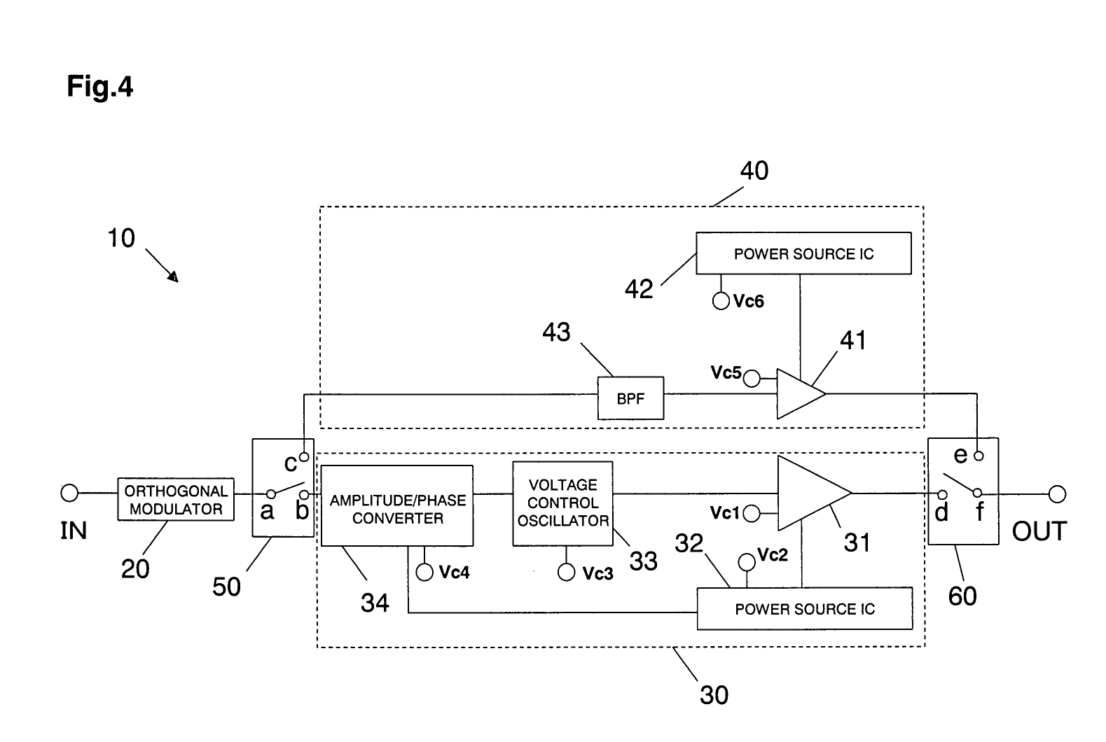

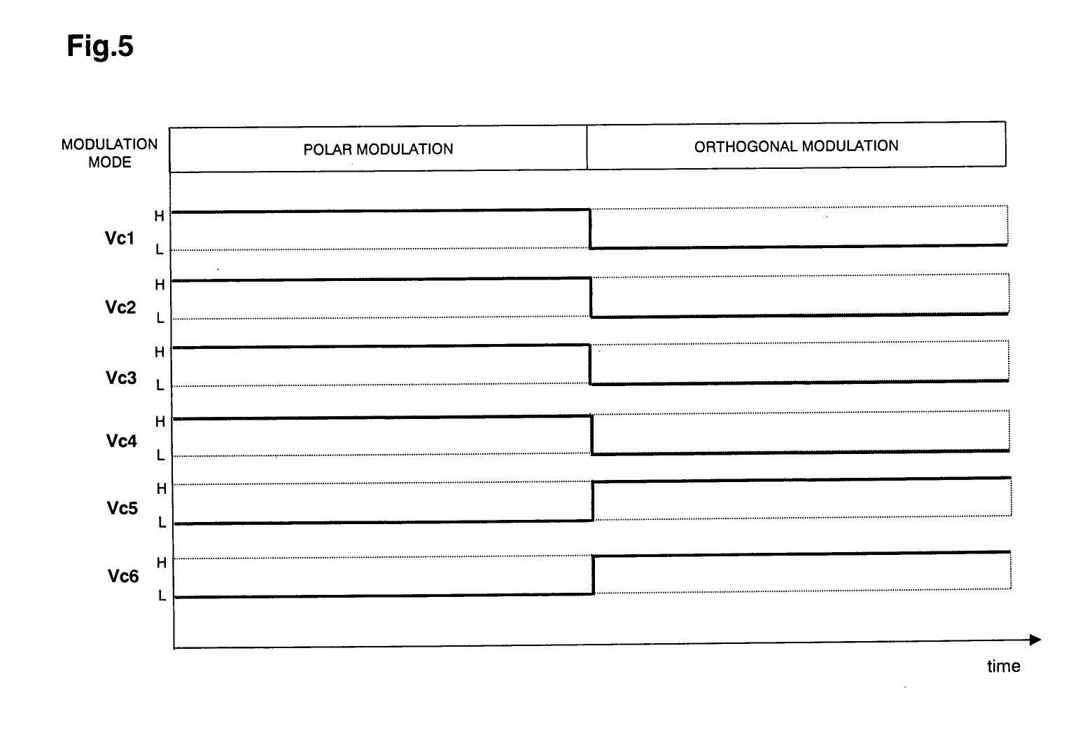

Hereinafter, an exemplary control method for controlling operations of respective component parts will be described. FIG. 4 is a diagram in which power control terminals Vc1 to Vc6 are provided to the first power amplifier 31, the first power source IC 32, the voltage control oscillator 33, the amplitude/phase converter 34, the second power amplifier 41, and the second power source IC 42 of the transmitting apparatus 10, respectively. FIG. 5 is a diagram showing a control timing of each of the power control terminals Vc1 to Vc6. A High level ranges 2.8 to 3.0V, and a Low level ranges 0 to 0.5V.

In the case of the polar modulation mode, the power control terminals Vc1 to Vc4 are each set to the High level so as to cause the first power amplifier 31, the first power source IC 32, the voltage control oscillator 33, and the amplitude/phase converter 34 in the polar-modulation-mode transmission circuit 30 to operate, whereas the power control terminals Vc5 and Vc6 are each set to the Low level so as to cause the second power amplifier 41 and the second power source IC 42 in the orthogonal-modulation-mode transmission circuit 40 not to operate.

In the case of the orthogonal modulation mode, the power control terminals Vc5 and Vc6 are each set to the High level, so as to cause the second power amplifier 41 and the second power source IC 42 in the orthogonal-modulation-mode transmission circuit 40 to operate, whereas the power control terminals Vc1 to Vc4 are each set to the Low level so as to cause the first power amplifier 31, the first power source IC 32, the voltage control oscillator 33, and the amplitude/phase converter 34 in the polar-modulation-mode transmission circuit 30 not to operate.

Accordingly, at the time of the high output, in the case where the polar-modulation-mode transmission circuit 30 operates in the polar modulation mode, the second power amplifier 41 and the second power source IC 42 in the orthogonal-modulation-mode transmission circuit 40 do not consume unnecessary power since the power control is performed at each of the power control terminals. On the other hand, at the time of the low output, in the case where the orthogonal-modulation-mode transmission circuit 40 operates in the orthogonal modulation mode, the first power amplifier 31, the first power source IC 32, the voltage control oscillator 33, and the amplitude/phase converter 34 in polar-modulation-mode transmission circuit 30 do not consume unnecessary power since the power control is performed at each of the power control terminals.

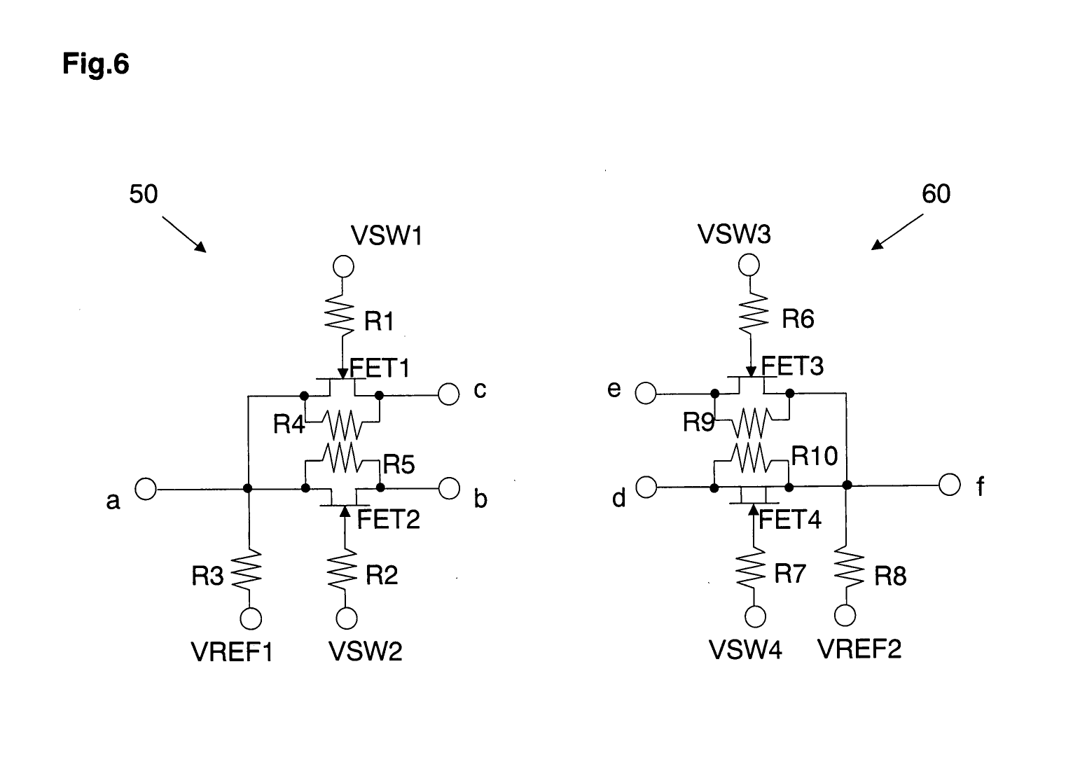

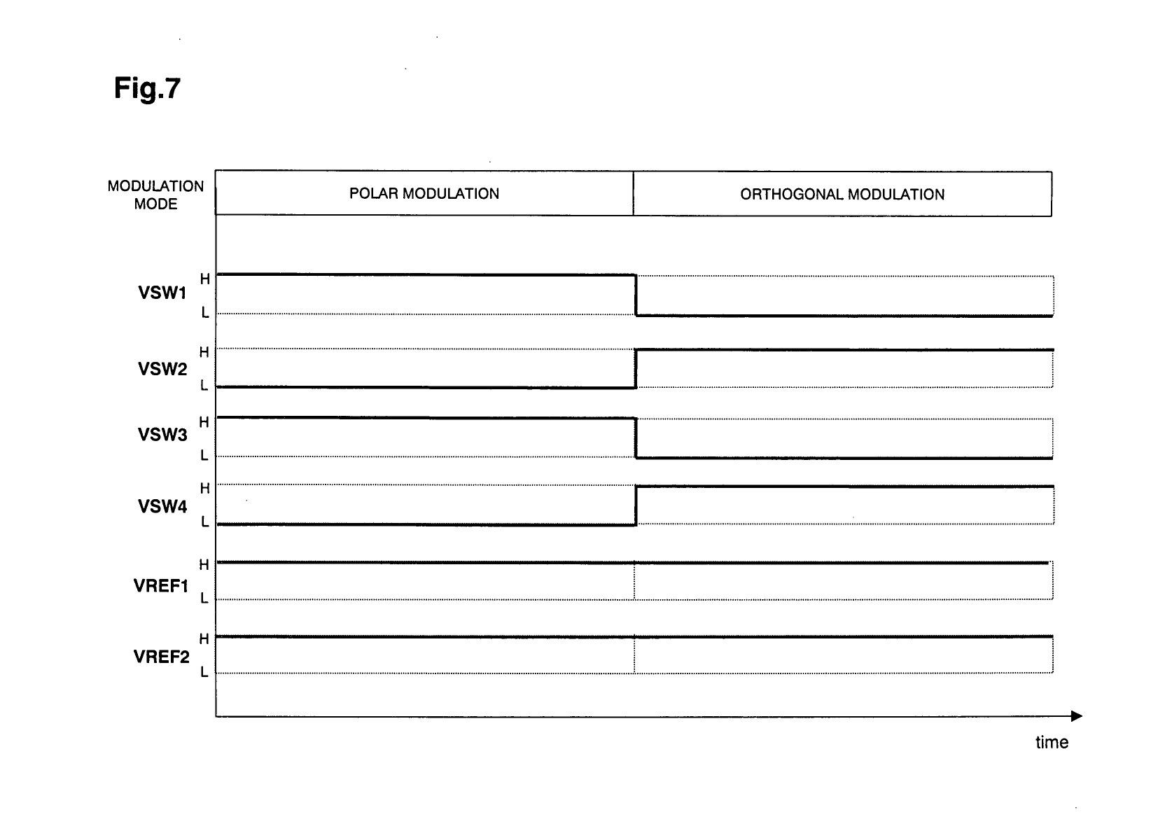

Next, specific configurations of the first switch 50 and the second switch 60 which switch between the polar-modulation-mode transmission circuit 30 and the orthogonal-modulation-mode transmission circuit 40 will be described. FIG. 6 is a diagram showing exemplary configurations of the first switch 50 and the second switch 60. In the first switch 50, the input terminal a is connected to the output of the orthogonal modulator 20, and the output terminal b is connected to the input of the polar-modulation-mode transmission circuit 30. Also, the output terminal c is connected to the input of the orthogonal-modulation-mode transmission circuit 40. In the second switch 60, the input terminal d is connected to the output of the polar-modulation-mode transmission circuit 30, and the input terminal e is connected to the output of the orthogonal-modulation-mode transmission circuit 40. Also, the output terminal f is connected to the output terminal OUT of the transmitting apparatus 10. Each of the first switch 50 and the second switch 60 is configurable with a field-effect transistor (FET), and performs a control at a timing shown in FIG. 7. The FET may be replaced with a bipolar transistor. The High level ranges 2.4 to 3.0V, and the Low level ranges 0 to 0.5V.

At the time of the high output, in the first switch 50, a reference voltage VREF1 and a VSW1 are each set to the High level, and a VSW2 is set to the Low level. Accordingly, an FET1 becomes nonconductive, whereas an FET2 becomes conductive. Therefore, a signal inputted to the input terminal a is outputted to the output terminal b. Further, in the second switch 60, a reference voltage VREF2 and a VSW3 are each set to the High level, and a VSW4 is set to the Low level. Accordingly, an FET 3 becomes nonconductive, whereas an FET4 becomes conductive. Therefore, a signal inputted to the input terminal d is outputted to the output terminal f.

At the time of the low output, in the first switch 50, the reference voltage VREF1, the VSW1, and, the VSW2 are set to the High level, the Low level, and the High level, respectively. Accordingly, the FET1 becomes conductive, whereas the FET2 becomes nonconductive. Therefore, the signal inputted to the input terminal a is outputted to the output terminal c. Further, in the second switch 60, the reference voltage VREF2, the VSW3, and the VSW4 are set to the High level, the Low level, and the High level, respectively. Accordingly, the FET3 becomes conductive, whereas the FET4 becomes nonconductive. Therefore, the signal inputted to the input terminal e is outputted to the output terminal f.

As above described, the polar-modulation-mode transmission circuit 30 for the high output and the orthogonal-modulation-mode transmission circuit 40 for the low output are provided individually, and the transmission circuits are switched in accordance with the power outputs, whereby the power consumption of the transmitting apparatus 10 can be minimized.

In the present embodiment of the present invention, the transmitting apparatus 10 has the second switch 60 which includes the input terminals d and e, and the output terminal f. However, an alternative configuration may be applied in which the second switch 60 is removed, and the output of the polar-modulation-mode transmission circuit 30 and that of the orthogonal-modulation-mode transmission circuit 40 are connected to the output terminal OUT. Further, the transmitting apparatus 10 includes the BPF 43 for performing band-limitation. However, the transmitting apparatus 10 may have a configuration in which the BPF 43 is removed, and instead the output terminal c of the first switch 50 is connected to the input terminal of the second power amplifier 41.

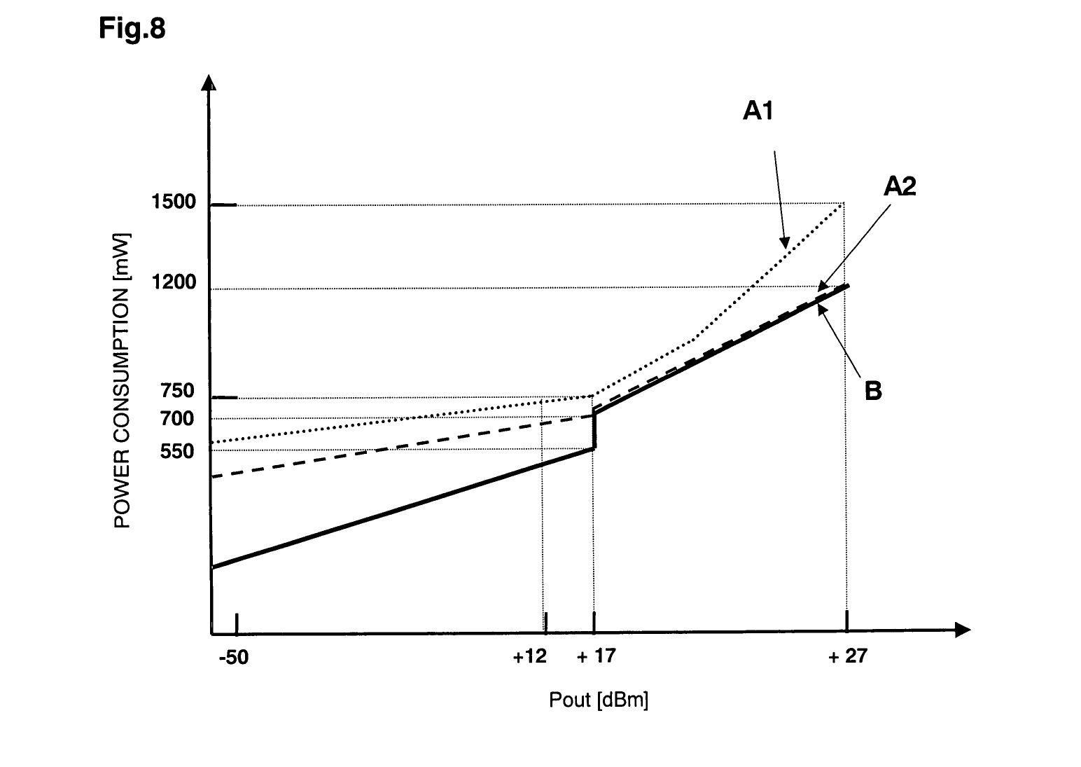

FIG. 8 is a diagram showing a feature A1 (represented by thin dashed lines) of the transmitting apparatus which operates only in the conventional orthogonal modulation mode, a feature A2 (represented by bold dashed lines) of the conventional transmitting apparatus 100, and a feature B (represented by a solid line) of the transmitting apparatus 10 of the present invention, with regard to a relation between the power output and the power consumption of each of the transmitting apparatuses. The transmitting apparatus 10 of the present invention realizes the low-power consumption operation over the wide range of power outputs.

In the conventional transmitting apparatus 100, the first DAC 103, the second DAC 106, and the modulating amplifier 107 are each of a device size and in a circuit configuration so as to be adapted to the high power output in the polar modulation mode. Therefore, even if the operation mode is switched to the orthogonal modulation mode at the time of the low output, the power consumption cannot be reduced sufficiently. On the other hand, in the present embodiment, the polar-modulation-mode transmission circuit 30 for the high output and the orthogonal-modulation-mode transmission circuit 40 for the low output are provided individually, and the transmission circuits are switched by using the first switch 50 and the second switch 60 in accordance with the power outputs. Accordingly, the power consumption of the transmitting apparatus 10 can be minimized.

As above described, according to the transmitting apparatus 10 according to the first embodiment of the present invention, the transmission circuits are switched in accordance with a magnitude of the output, whereby the maximum efficiencies of the transmission circuits can be derived. This is because the polar-modulation-mode transmission circuit 30 and the orthogonal-modulation-mode transmission circuit 40 include the devices dedicated thereto, respectively, and consequently, each of the devices can be operated highly efficiently in accordance with whether the power output is high or low. Therefore, the transmitting apparatus according to the first embodiment of the present invention is capable of minimizing the power consumption of the transmitting apparatus over the wide range of power outputs, and as a result, the low-power consumption operation is realized and the talk time of the mobile phone is increased.

### Second Embodiment

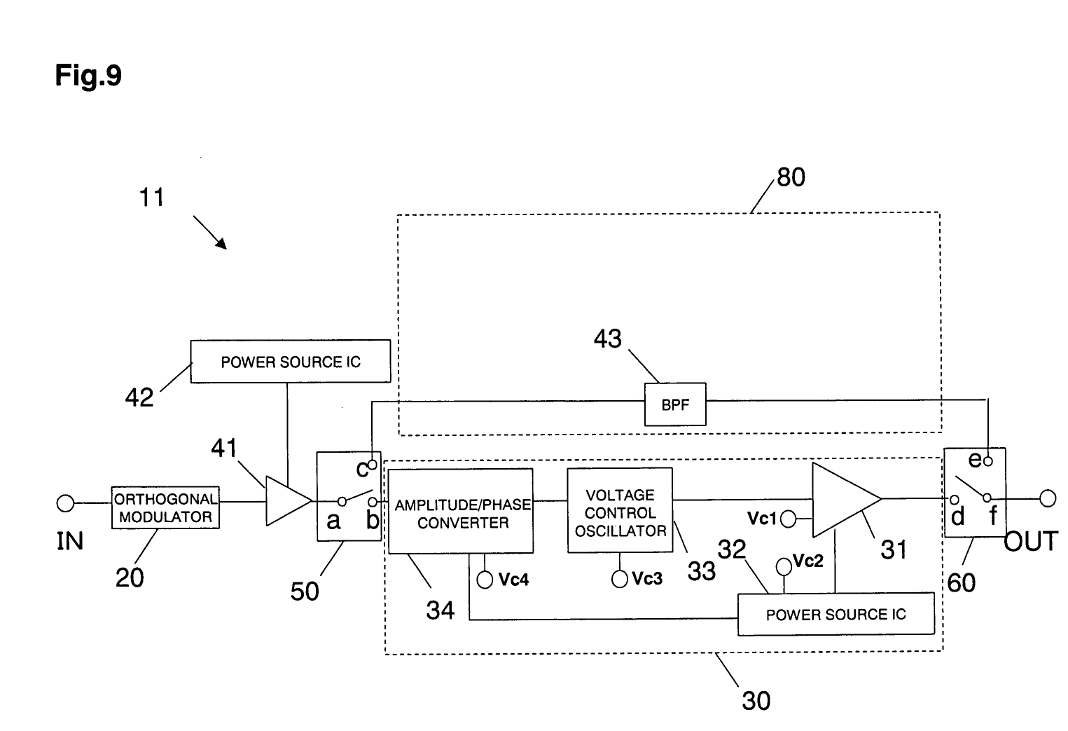

In a second embodiment of the present invention, a part of the transmitting apparatus 10 according to the first embodiment is changed. FIG. 9 is a diagram showing a circuit configuration of a transmitting apparatus 11 according to the second embodiment of the present invention. An orthogonal-modulation-mode transmission circuit 80 is different from the orthogonal-modulation-mode transmission circuit 40 according to the first embodiment in that the second power amplifier 41 and the second power source IC 42 are removed therefrom, and only the BPF 43 is included therein.

The transmitting apparatus 11 according to the second embodiment includes the orthogonal modulator 20, the polar-modulation-mode transmission circuit 30, the second power amplifier 41, the second power source IC 42, the first switch 50, the second switch 60, and the orthogonal-modulation-mode transmission circuit 80. An input terminal IN of the transmitting apparatus 11 is connected to the orthogonal modulator 20. The output of the orthogonal modulator 20 is connected to the input terminal of the second power amplifier 41. The output of the second power source IC 42 is connected to the power supply terminal of the second power amplifier 41. In the first switch 50, the input terminal a is connected to the output of the second power amplifier 41, and the output terminal b is connected to the input of the polar-modulation-mode transmission circuit 30. Also, the output terminal c is connected to an input of the orthogonal-modulation-mode transmission circuit 80. In the second switch 60, the input terminal d is connected to the output of the polar-modulation-mode transmission circuit 30, and the input terminal e is connected to an output of the orthogonal-modulation-mode transmission circuit 80. Also, the output terminal f is connected to the output terminal OUT of the transmitting apparatus 11. Note that the polar-modulation-mode transmission circuit 30, the first switch 50, and the second switch 60 according to the present embodiment respectively have the same configurations as those according to the first embodiment.

In the transmitting apparatus 11 according to the second embodiment, the orthogonal modulator 20 generates a modulated signal from a signal inputted to the transmitting apparatus 11. The signal generated by the orthogonal modulator 20 is amplified by the second power amplifier 41 by using a voltage signal generated by the second power source IC 42. The first switch 50 and the second switch 60 are controlled by a control section (not shown) which determines whether the power output of the transmitting apparatus 11 is high or low in accordance with the signal inputted to the transmitting apparatus 11. The signal amplified by the second power amplifier 41 is modulated by the polar-modulation-mode transmission circuit 30 at the time of the high output, whereas the amplified signal is band-limited by a BPF 43 of the orthogonal-modulation-mode transmission circuit 80 at the time of the low output. The signal is then transmitted to the output terminal OUT. The switching at each of the first switch 50 and the second switch 60 is performed in the same manner as that in the first embodiment.

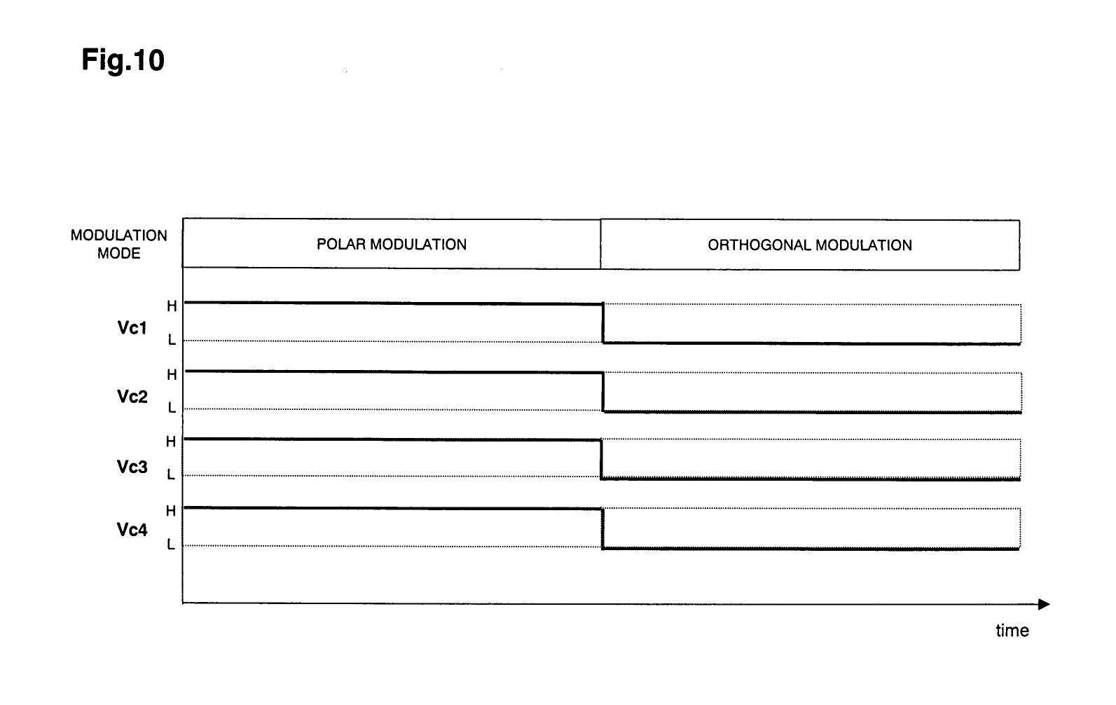

As shown in FIG. 9, the first power amplifier 31, the first power source IC 32, the voltage control oscillator 33 and the amplitude/phase converter 34 of the transmitting apparatus 11 have the power control terminals Vc1 to Vc4, respectively. FIG. 10 is a diagram showing a control timing of each of the power control terminals Vc1 to Vc4. The High level ranges 2.8 to 3.0V, whereas the Low level ranges 0 to 0.5V.

In the case of the polar modulation mode, the power control terminals Vc1 to Vc4 are each set to the High level so as to cause the first power amplifier 31, the first power source IC 32, the voltage control oscillator 33, and the amplitude/phase converter 34 in the polar-modulation-mode transmission circuit 30 to operate.

In the case of the orthogonal modulation mode, the power control terminals Vc1 to Vc4 are each set to the Low level so as to cause the first power amplifier 31, the first power source IC 32, the voltage control oscillator 33, and the amplitude/phase converter 34 in the polar-modulation-mode transmission circuit 30 not to operate. The configuration of the transmitting apparatus 11 is not limited to that shown in FIG. 9. Instead, the transmitting apparatus 11 may have a configuration, for example, in which the BPF 43 for performing the band-limitation is removed, and the output terminal c of the first switch 50 is connected to the input terminal e of the second switch 60.

As above described, in the transmitting apparatus 11 according to the second embodiment of the present invention, the transmission circuits are switched in accordance with the magnitude of the output, whereby the maximum efficiencies of the transmission circuits can be derived in accordance with the output. This is because, the polar-modulation-mode transmission circuit 30 has the dedicated devices, and consequently, each of the devices is operated highly efficiently at the time of the high output. Further, in the transmitting apparatus 11 according to the second embodiment of the present invention, a function of the second power amplifier 41 is provided after the output of the orthogonal modulator 20, whereby it is possible to reduce the number of the power control terminals to be controlled compared to the transmitting apparatus 10 according to the first embodiment. Accordingly, at the time of switching from the polar modulation mode to the orthogonal modulation mode (and vice versa), the power control terminals can be controlled in a simplified manner, and as a result, deterioration in a communication quality, which is caused by a timing delay at the time of the switching, can be avoided. Further, a table memory capacity required for controlling may be also reduced.

### Third Embodiment

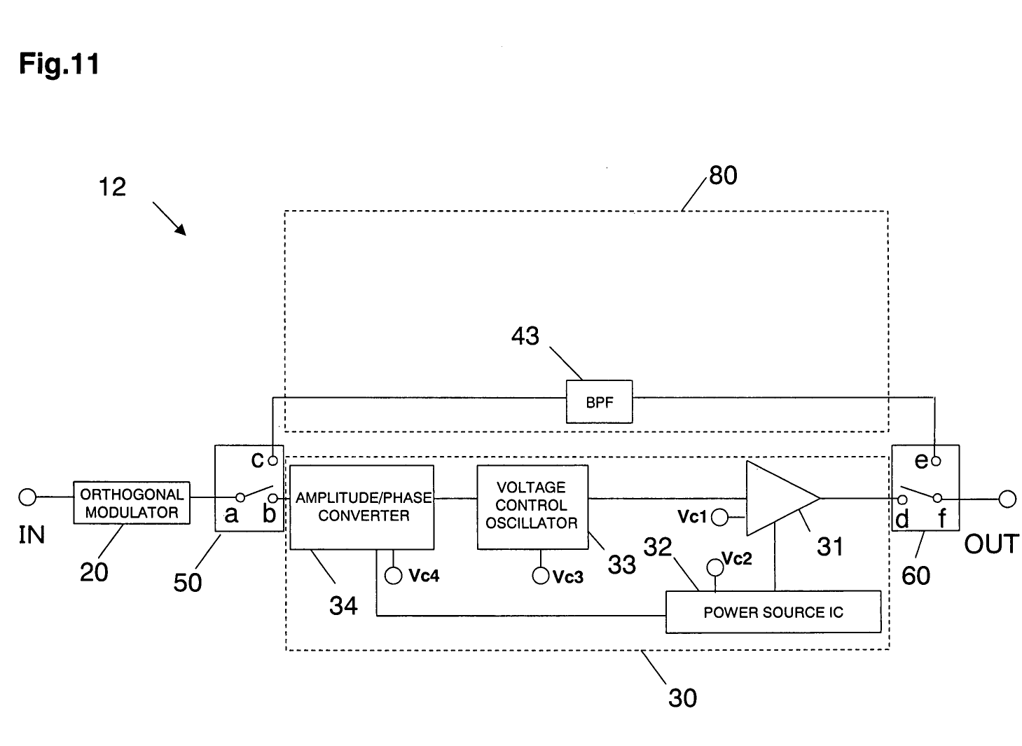

In a third embodiment of the present invention, a part of the transmitting apparatus 11 according to the second embodiment is changed. FIG. 11 is a diagram showing a circuit configuration of a transmitting apparatus 12 according to the third embodiment of the present invention. The transmitting apparatus 12 corresponds to the transmitting apparatus 11 according to the second embodiment from which the second power amplifier 41 and the second power source IC 42 have been removed. The output of the orthogonal modulator 20 is connected to the input terminal a of the first switch 50. Each of the polar-modulation-mode transmission circuit 30, the first switch 50, the second switch 60, and the orthogonal-modulation-mode transmission circuit 80 according to the present embodiment has the same configuration as that in the second embodiment.

In the transmitting apparatus 12 according to the third embodiment, the orthogonal modulator 20 generates a modulated signal from a signal inputted to the transmitting apparatus 12. The first switch 50 and the second switch 60 are controlled by the control section (not shown) which determines whether the power output of the transmitting apparatus 12 is high or low in accordance with the signal inputted to the transmitting apparatus 12. Accordingly, the signal generated by the orthogonal modulator 20 is modulated by the polar-modulation-mode transmission circuit 30 at the time of the high output, whereas the generated signal is band-limited by the BPF 43 of the orthogonal-modulation-mode transmission circuit 80 at the time of the low output, and then the signal is outputted to the output terminal OUT. The switching at each of the first switch 50 and the second switch 60 is performed in the same manner as that in the first embodiment.

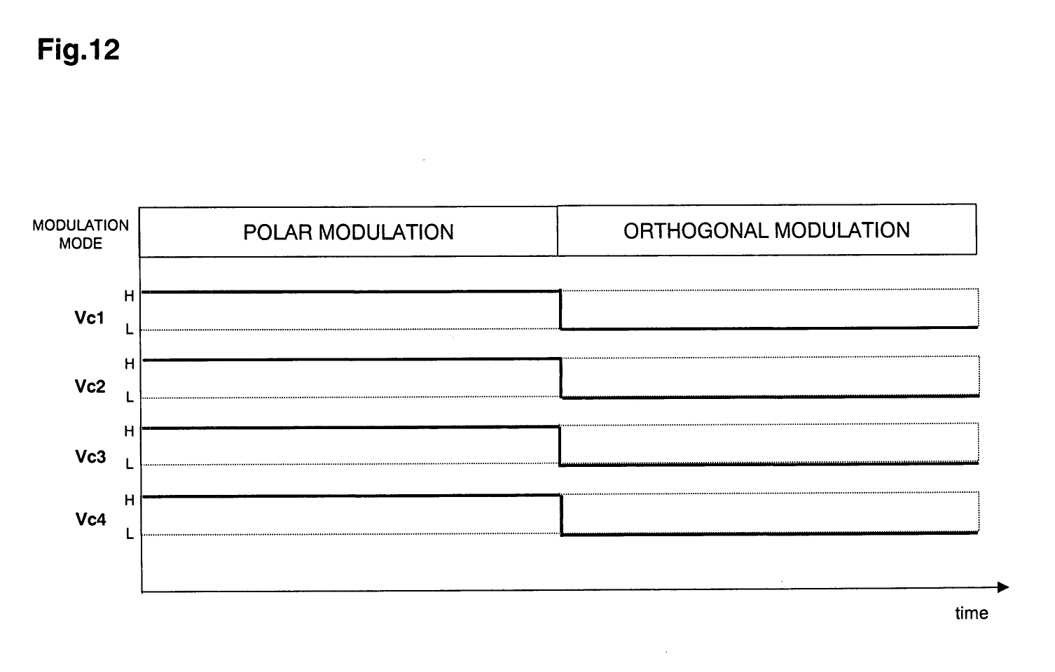

As shown in FIG. 11, the first power amplifier 31, the first power source IC 32, the voltage control oscillator 33, and the amplitude/phase converter 34 of the transmitting apparatus 12 have the power control terminals Vc1 to Vc4, respectively. FIG. 12 is a diagram showing a control timing of the power control terminals Vc1 to Vc4. The High level ranges 28 to 3.0V, whereas the Low level ranges 0 to 0.5V.

In the case of the polar modulation mode, the power control terminals Vc1 to Vc4 are each set to the High level so as to cause the first power amplifier 31, the first power source IC 32, the voltage control oscillator 33 and the amplitude/phase converter 34 in the polar-modulation-mode transmission circuit 30 to operate.

In the case of the orthogonal modulation mode, the power control terminals Vc1 to Vc4 are each set to the Low level so as to cause the first power amplifier 31, the first power source IC 32, the voltage control oscillator 33 and the amplitude/phase converter 34 in the polar-modulation-mode transmission circuit 30 not to operate. The configuration of the transmitting apparatus 12 is not limited to that shown in FIG. 11. Instead, the transmitting apparatus 12 may have a configuration, for example, in which the BPF 43 for performing the band-limitation is removed, and the output terminal c of the first switch 50 is connected to the input terminal e of the second switch 60.

As above described, according to the transmitting apparatus 12 according to the third embodiment of the present invention, the transmission circuits are switched in accordance with the magnitude of the output, whereby the maximum efficiencies of the transmission circuits can be derived. This is because, the polar-modulation-mode transmission circuit 30 has the dedicated devices, and consequently, each of the devices is operated highly efficiently at the time of the high output. Further, in the transmitting apparatus 12 according to the third embodiment of the present invention, power consumptions caused by the second power amplifier 41 and the second power source IC 42, which are included in each of the transmitting apparatuses according to the first and second embodiments, can be eliminated at the time of the low output. That is, the power consumption of the transmitting apparatus 12 can be further reduced. Still further, at the time of switching from the polar modulation mode to the orthogonal modulation mode (and vice versa), the power control terminal can be controlled in a simplified manner as with the case of the second embodiment. As a result, the low-power consumption operation of the transmitting apparatus is realized, and a table memory capacity required for controlling can be also reduced.

### Fourth Embodiment

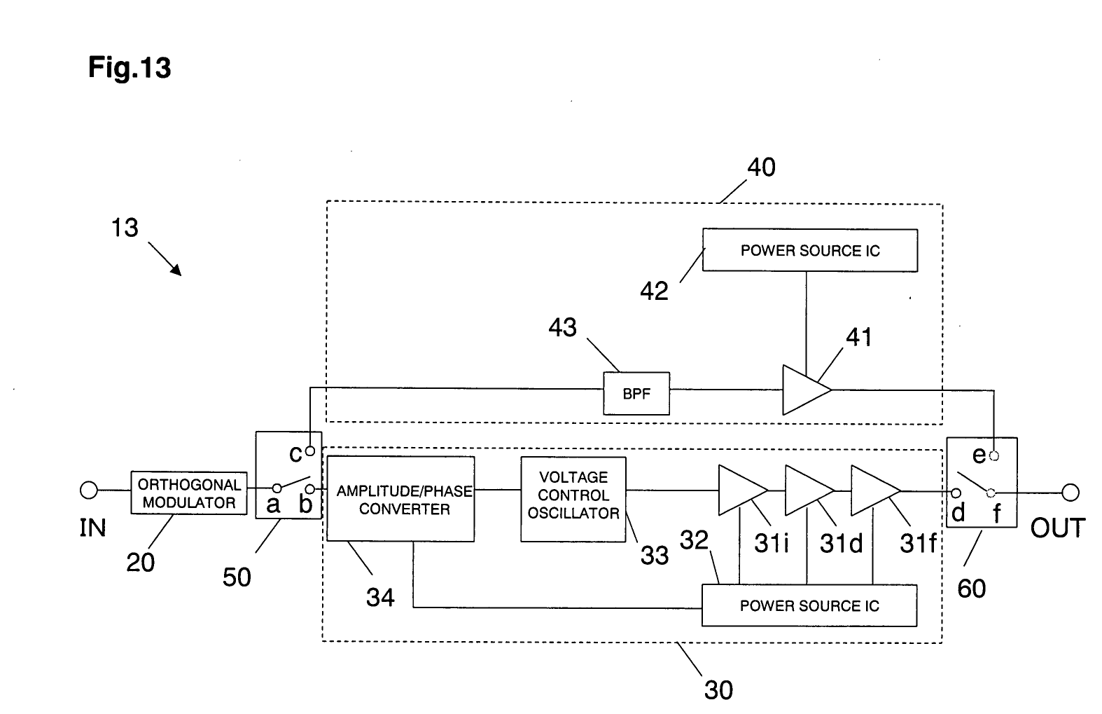

In a fourth embodiment of the present invention, a part of the transmitting apparatus 10 according to the first embodiment is changed. FIG. 13 is a diagram showing another specific example of the power amplifier included in the transmitting apparatus 10 shown in FIG. 2. Since the first power amplifier 31 is adapted to the high output, a high gain is required. In the case of the power amplifier in a transmitting apparatus 13 according to the present embodiment, amplifiers 31i, 31d and 31f are respectively connected in a cascade form so as to be configured with a multiple-amplifier stage, whereby the high gain is achieved.

In the transmitting apparatus 13 according to the present embodiment, a case is described where the first power amplifier 31 in the transmitting apparatus 10 shown in FIG. 2 is replaced with a three-stage power amplifier in the cascade form, and the second power amplifier 41 in the same is replaced with a one-stage power amplifier. However, the power amplifier is not limited to this, and any n-stage power amplifier (n is an integer) in the cascade form may be used in any case.

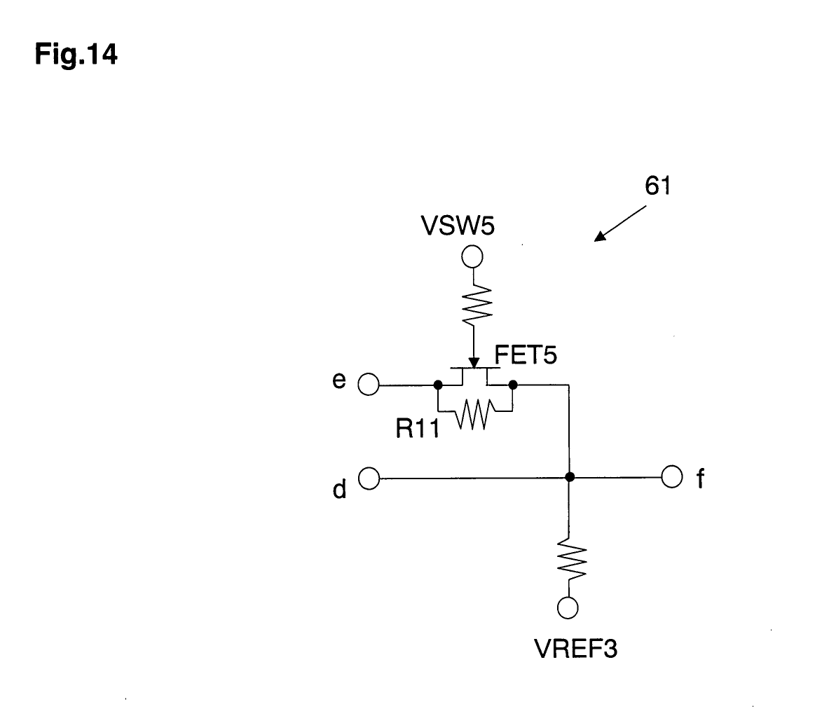

The second switch 60 according to each of the first to fourth embodiments may be configured in a manner shown in FIG. 14, instead of that shown in FIG. 6. In a switch 61 shown in FIG. 14, an input terminal d is connected to an output of the polar-modulation-mode transmission circuit, and an input terminal e is connected to an output of the orthogonal-modulation-mode transmission circuit. Also, an output terminal f is connected to an output terminal OUT of the transmitting apparatus. The second switch 61 is controlled together with the first switch as described in the first embodiment. At the time of the high output, a reference voltage VREF3 is set to the High level, a VSW5 is set to the High level, and a FET5 is caused to be nonconductive so as to cause the signal inputted from the input terminal d to be outputted to the output terminal f. At the time of the low output, the reference voltage VREF3 is set to the High level, the VSW5 is set to the Low level, and the FET5 is caused to be conductive so as to cause the signal inputted from the input terminal e to be outputted to the output terminal f.

The transmitting apparatus according to each of the first to fourth embodiments may be applicable not only to the UMTS format, but also to various mobile communication formats (a CDMA (IS-95), a GSM, an EDGE, a WCDMA, a PCS, a DCS, a PDC, a CDMA2000, a PHS, a W-LAN and the like).

While the invention has been described in detail, the foregoing description is in all aspects illustrative and not restrictive. It is understood that numerous other modifications and variations can be devised without departing from the scope of the invention.

1. A transmitting apparatus for generating a modulated signal and for amplifying power, the transmitting apparatus comprising:
an orthogonal modulator for generating the modulated signal by using an input signal;
a polar-modulation-mode transmission circuit which includes a first power amplifier whose input terminal receives a phase component of the modulated signal generated by the orthogonal modulator and whose power supply terminal receives an amplitude component of the modulated signal generated by the orthogonal modulator, and which polar-modulates the modulated signal,
an orthogonal-modulation-mode transmission circuit which includes a second power amplifier whose input terminal receives the modulated signal generated by the orthogonal modulator and whose power supply terminal receives a constant voltage, and which transmits the modulated signal; and
a switch for connecting the orthogonal modulator with the polar-modulation-mode transmission circuit at the time of a high output when a power output of the transmitting apparatus is at a high level, and for connecting the orthogonal modulator with the orthogonal-modulation-mode transmission circuit at the time of a low output when the power output of the transmitting apparatus is at a low level.

2. The transmitting apparatus according to claim 1, wherein
the polar-modulation-mode transmission circuit further includes:
an amplitude/phase converter for dividing the modulated signal generated by the orthogonal modulator into the amplitude component and the phase component;
a voltage control oscillator for generating a phase-modulated signal having a constant amplitude by using the phase component which is divided into by the amplitude/phase converter; and
a first power source IC for generating an amplitude-modulated signal by using the amplitude component which is divided into by the amplitude/phase converter,
an output of the voltage control oscillator is inputted to the input terminal of the first power amplifier, and an output of the first power source IC is inputted to the power supply terminal of the first power amplifier.

3. The transmitting apparatus according to claim 2, wherein the orthogonal-modulation-mode transmission circuit further includes a second power source IC for supplying the constant voltage to the power supply terminal of the second power amplifier.

4. The transmitting apparatus according to claim 3, wherein
the orthogonal-modulation-mode transmission circuit further includes a band-pass filter for band-limiting the modulated signal generated by the orthogonal modulator, and
an output of the band-pass filter is inputted to the input terminal of the second power amplifier.

5. The transmitting apparatus according to claim 1, wherein a device size of the second power amplifier included in the orthogonal-modulation-mode transmission circuit is smaller than a device size of the first power amplifier included in the polar-modulation-mode transmission circuit.

6. The transmitting apparatus according to claim 1, wherein a ratio of a device size of the first power amplifier included in the polar-modulation-mode transmission circuit to a device size of the second power amplifier included in the orthogonal-modulation-mode transmission circuit corresponds to a ratio of the power output at the time of the high output to the power output at the time of the low output.

7. The transmitting apparatus according to claim 3, wherein a drive performance of the second power source IC included in the orthogonal-modulation-mode transmission circuit is lower than a drive performance of the first power source IC included in the polar-modulation-mode transmission circuit.

8. The transmitting apparatus according to claim 3, wherein a circuit scale of the second power source IC included in the orthogonal-modulation-mode transmission circuit is smaller than a circuit scale of the first power source IC included in the polar-modulation-mode transmission circuit.

9. The transmitting apparatus according to claim 3, wherein a device size of the second power source IC included in the orthogonal-modulation-mode transmission circuit is smaller than a device size of the first power source IC included in the polar-modulation-mode transmission circuit.

10. The transmitting apparatus according to claim 1, wherein, either of the polar-modulation-mode transmission circuit or the orthogonal-modulation-mode transmission circuit is not connected to the orthogonal modulator, and does not consume unnecessary power.

11. The transmitting apparatus according to claim 4, wherein a drive performance of the second power source IC included in the orthogonal-modulation-mode transmission circuit is lower than a drive performance of the first power source IC included in the polar-modulation-mode transmission circuit.

12. The transmitting apparatus according to claim 4, wherein a circuit scale of the second power source IC included in the orthogonal-modulation-mode transmission circuit is smaller than a circuit scale of the first power source IC included in the polar-modulation-mode transmission circuit.

13. The transmitting apparatus according to claim 4, wherein a device size of the second power source IC included in the orthogonal-modulation-mode transmission circuit is smaller than a device size of the first power source IC included in the polar-modulation-mode transmission circuit.
